(19) United States
(12) Patent Application Publication
(10) Pub. No.: US 2025/0121726 A1
(43) Pub. Date: Apr. 17, 2025

(54) ELECTRIFIED VEHICLE

(71) Applicant: TOYOTA JIDOSHA KABUSHIKI KAISHA, Toyota-shi (JP)

(72) Inventor: Tateki HANASHIMA, Nagoya-shi (JP)

(73) Assignee: TOYOTA JIDOSHA KABUSHIKI KAISHA, Toyota-shi (JP)

(21) Appl. No.: 18/749,870

(22) Filed: Jun. 21, 2024

(30) Foreign Application Priority Data
Oct. 11, 2023 (JP) 2023-175814

(51) Int. Cl. B60L 53/63; B60L 53/16; B60L 53/68

(52) U.S. Cl. CPC B60L 53/63; B60L 53/16; B60L 53/68

(57) ABSTRACT

Electrified vehicle includes a connector, a battery, a charging relay, and an ECU. The connector is formed to be connectable to an externally provided electric power plug. The charging relay is provided between the connector and the battery. ECU controls at least one of charge/discharge of the battery. When the electrified vehicle is configured for smart charging, the charging relay is kept off for a fixed period of time after the electric power plug is connected to the connector.

### CROSS-REFERENCE TO RELATED APPLICATION

This application claims priority to Japanese Patent Application No. 2023-175814 filed on Oct. 11, 2023, incorporated herein by reference in its entirety.

### BACKGROUND

### 1. Technical Field

The present disclosure relates to an electrified vehicle.

### 2. Description of Related Art

The vehicle described in Japanese Unexamined Patent Application Publication No. 2021-027721 (JP 2021-027721 A) includes a secondary battery, and is formed so that the secondary battery can be charged and discharged in accordance with an electric power supply and demand adjustment request. Further, a vehicle management device of the vehicle records the number of times of opening and closing operation of a charging relay of the vehicle, and prohibits the vehicle from participating in the electric power supply and demand adjustment request when the opening and closing operation of the charging relay exceeds a threshold value.

### SUMMARY

In recent years, the use of a secondary battery mounted on a vehicle for a virtual power plant (VPP) and the like has been discussed. The VPP is, for example, a system for load-leveling of an electric power system and supplying electric power to the electric power system when there is a shortage of the electric power in the electric power system.

The VPP includes a vehicle including a secondary battery, and a server that communicates with the vehicle. The server formulates a charging and discharging plan for charging and discharging the secondary battery of the vehicle based on the state of the electric power system, and transmits the charging and discharging plan to the vehicle. The vehicle supplies the electric power to the electric power system or receives the electric power from the electric power system based on the charging and discharging plan received from the server.

On the other hand, a vehicle that is able to be charged from or discharged to the outside generally includes an inlet to which an electric power plug provided externally is connected, and the vehicle generally starts charging or discharging when the electric power plug is connected.

Therefore, when the vehicle receives the charging and discharging plan after the electric power plug is connected, the charging relay is turned on once when the electric power plug is connected. After that, when the vehicle receives the charging and discharging plan, the charging relay is turned off depending on the content of the charging and discharging plan. Then, when charging or the like is started based on the charging and discharging plan, the charging relay is turned on again.

As described above, in the conventional vehicles, there is a problem that the number of times of on/off of the charging relay may increase when the VPP is performed.

Noted that the problem described above is not limited to the case where the VPP is performed, and for example, the same problem arises when the vehicle receives a timer charge or a charging and discharging plan related to Vehicle to Home (V2H) transmitted from the server and the vehicle is charged based on the plan after the electric power connector is connected.

The present disclosure has been made to solve the above problem. An object of the present disclosure is to provide a vehicle that is able to perform at least one of charging and discharging, and in which the number of times of on/off of the charging relay is suppressed from increasing when charging or discharging is performed based on various kinds of information received from the outside.

An electrified vehicle according to the present disclosure includes
a connector to which an electric power plug provided externally is connected,
a secondary battery,
a charging relay provided between the connector and the secondary battery, and
a control device that controls at least one of charging and discharging of the secondary battery.
When smart charging of the electrified vehicle is set, the charging relay remains off for a fixed period of time after the electric power plug is connected to the connector.
The control device is configured to be able to communicate with a server.
The server is able to communicate with a user terminal used by a user of the electrified vehicle.
A setting of the smart charging is set based on input information from the user terminal.
The control device receives a charging and discharging plan set by the server based on the input information.
The control device is configured to be able to communicate with a server.
The server sets the charging and discharging plan of the electrified vehicle according to an electric power supply and demand adjustment request for adjusting power supply and demand in an electric power system.
The control device receives the charging and discharging plan from the server.
When the charging and discharging plan is not received after a lapse of the fixed period of time, the charging relay is turned on.
The fixed period of time is two seconds or more and 15 minutes or less.

According to the electrified vehicle of the present disclosure, in a vehicle that is able to perform at least one of charging and discharging, the number of times of on/off of the charging relay is suppressed from increasing when charging or discharging is performed based on various kinds of information received from the outside.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a configuration of a charge/discharge control system 1 according to an embodiment;

FIG. 2 is a diagram showing a configuration of an electrified vehicle 10 according to the embodiment;

FIG. 3 is a diagram illustrating a control flow executed by electrified vehicle 10, the system managing server 100, the residence 200, the mobile terminal 300, and the server 400;

FIG. 4 is a diagram showing the control flow performed by an electrified vehicle 10, the system managing server 100, the residence 200, the mobile terminal 300, and the server 400; and

FIG. 5 is a diagram illustrating an exemplary charging and discharging planning created by the server 400 in accordance with settings previously entered by the user.

### DETAILED DESCRIPTION OF EMBODIMENTS

An embodiment of the present disclosure will be described in detail below with reference to the drawings. The same or corresponding parts are denoted by the same signs throughout the drawings, and description thereof will not be repeated.

### Configuration of Charge/Discharge System

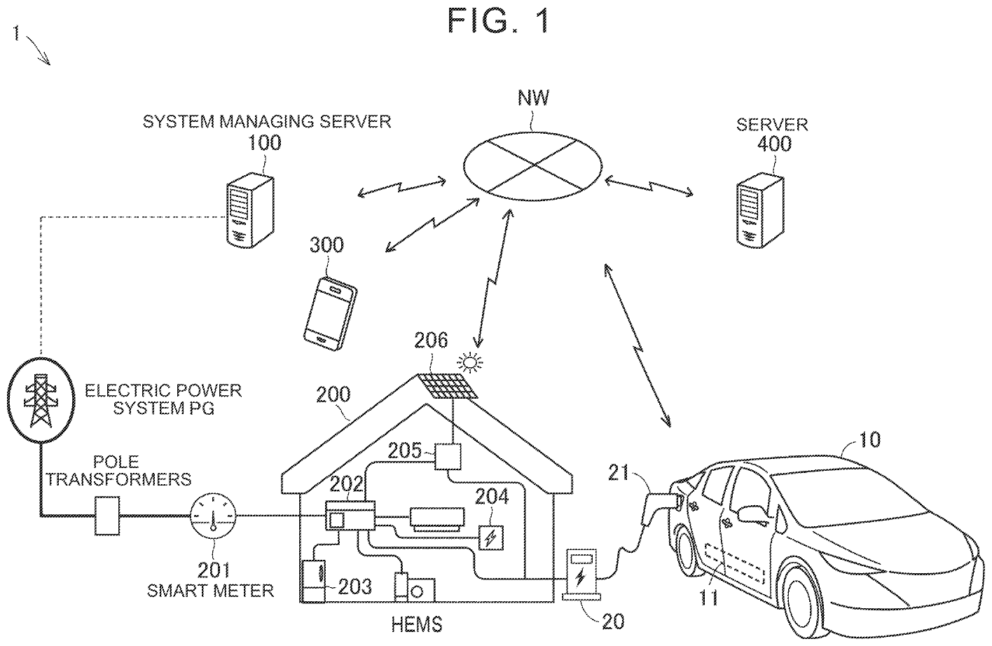

FIG. 1 is a diagram illustrating a configuration of a charge/discharge control system 1 according to the present embodiment. The charge/discharge control system 1 includes an electrified vehicle 10, a EVSE (Electric Vehicle Supply Equipment) 20, an electric power system PG, a system managing server 100, a residence 200, a mobile terminal 300, and a server 400. Electrified vehicle 10, the system managing server 100, the residence 200, the mobile terminal 300, and the server 400 are configured to be able to communicate with each other through a network.

Electrified vehicle 10 charges and discharges electric power via a EVSE 20 installed in the residence 200. Electrified vehicle 10 include, for example, PHEV (Plug-in Hybrid Electric Vehicle), BEV (Battery Electric Vehicle), and FCEV (Fuel Cell Electric Vehicle). Note that electrified vehicle 10 may be configured to be capable of only one of external power supply and external charge.

EVSE 20 is a facility provided in the residence 200. EVSE 20 is formed so that the battery 11 of electrified vehicle 10 can be charged by using electric power supplied from an external power source (an electric power generation facility of the electric power system PG or the residence 200). EVSE 20 is formed to be able to be discharged (supplied) from the battery 11 of electrified vehicle 10 to the residence 200 or the electric power system PG. EVSE 20 includes, for example, inverters and converters, and is configured to be capable of converting direct current (battery 11) and alternating current (home electric power line) electric power. EVSE 20 is controlled by HEMS controllers 204 provided in the residence 200.

the electric power system PG is an electric power grid constructed by a power plant and a transmission and distribution facility (not shown). the electric power system PG is connected to the residence 200 via a pole transformer for lowering the electric power supplied from the electric power system PG.

The residence 200 includes a smart meter 201, a HEMS compatible distribution board 202, an electric power load facility 203, a HEMS controller 204, a PCS (Power Conditioner system) 205, a photovoltaic power generation facility 206, and a EVSE 20.

The smart meter 201 has a function of measuring the amount of electric power flowing in and out of the residence 200, and is located between the connected columnar transformer and HEMS compatible distribution board 202. HEMS compatible distribution board 202 is connected to the electric power load facility 203, HEMS controllers 204, and EVSE 20. HEMS compatible distribution board 202 is configured to distribute the electric power supplied from the electric power system PG to the connected devices, and to measure the electric power consumption of each of the circuits. The electric power load facility 203 refers to, for example, electric appliances such as a heat pump type water heater, a refrigerator, and a heating and cooling device.

HEMS controllers 204 are formed to be able to communicate with HEMS compatible distribution board 202, the electric power load facility 203, the photovoltaic power generation facility 206, and EVSE 20. HEMS controllers 204 acquire the residential electric power data and control the operation of the devices in the residence 200. The residential electric power information includes information on the respective devices connected to HEMS compatible distribution board 202 (the electric power consumed by the electric power load facility 203 and the electric power generated by the photovoltaic power generation facility 206) and the electricity rate of the electric power supplied from the electric power system PG.

PCS 205 converts a current supplied from the photovoltaic power generation facility 206 from direct current to alternating current, and supplies the converted current to HEMS compatible distribution board 202. In addition, PCS 205 adjusts the voltage/frequency of the direct current supplied from the photovoltaic power generation facility 206 and supplies the rectified voltage/frequency to EVSE 20. Alternatively, PCS 205 converts the current from the photovoltaic power generation facility 206 or electrified vehicle 10 from direct current to alternating current, and supplies the converted current to the electric power system.

The system managing server 100 manages electric power supply and demand in the electric power system PG managed by the system managing server 100. The system managing server 100 is, for example, a server managed by an electric power company (such as a general power transmission and distribution company).

The server 400 is a server managed by an aggregator. An aggregator is an electric utility that provides an energy management service by bundling a plurality of power adjustment resources such as a region and a predetermined facility.

### Smart Charging Features

The user operates the mobile terminal 300 to make settings related to smart charging of electrified vehicle 10. Note that the mobile terminal 300 is an example of a “user terminal” of the present disclosure.

Here, the smart charging is a charging method corresponding to at least one of eco-charging, VPP, and V2H. The eco-charging is a charging method including a timer charging function and various charging setting functions. The timer charging function is a function that allows the user to set the target SOC of the battery 11 at the scheduled departure time and the scheduled departure time of electrified vehicle 10. Further, the various charging setting functions include a setting for charging the battery 11 to reduce the electricity rate, and a setting for charging using electric power generated by an electric power generation method with a small CO2 emission. Specifically, the power generation methods with low CO2 emissions include photovoltaic power generation and hydroelectric power generation.

VPP is to control charging and discharging of a plurality of the battery 11 of a plurality of electrified vehicle 10 connected to the electric power system, for example, for the purpose of load leveling of the electric power system and adjusting the electric power supply and demand balance of the electric power system.

A detailed description of VPP is provided below. The system managing server 100 requests (first request) the server 400 to adjust the electric power supply and reception of the electric power system PG based on the electric power consumed in the electric power system PG managed by the system managing server 100 and the generated power by the respective power adjustment resources. The first request includes information indicating a charging and discharging execution time (time zone) requested from the server 400, and information indicating a charging amount (charging power) and a discharging amount (discharging power).

Based on the first request, the server 400 requests (second request) the electric power supply and demand adjustment to the respective power resources (including electrified vehicle 10) managed by the server 400. The second request includes information indicating the charging and discharging execution time (time zone) and information indicating the charging amount (charging power) and the discharging amount (discharging power). Each power resource replies to the server 400 whether the second request can be handled. The server 400 plans charging and discharging performed by each power resource based on whether a response from each power resource is possible. It should be noted that, generally, a user acquires a reward from an operating firm of the server 400 by performing predetermined charging and discharging at an execution time included in the second request by electrified vehicle 10.

V2H (Vehicle to Home) The system is a system that makes power control in HEMS more efficient by effectively utilizing the battery 11 mounted on electrified vehicle 10.

HEMS controllers 204 control charging and discharging of the battery 11 using electrified vehicle 10 connected to EVSE 20 as an electric power resource, based on the residential power data. Specifically, HEMS controllers 204 discharge the battery 11 and store the electric power generated by the photovoltaic power generation facility 206 in the battery 11 and discharge the electric power at night in a period in which the electric power usage reaches a peak. As a result, the electric power supplied from the electric power system PG can be suppressed.

The setting regarding the smart charging performed by the user is a setting regarding the scheduled vehicle departure time of electrified vehicle 10, the target SOC of the scheduled vehicle departure time, whether to apply various charging setting functions, and whether to utilize electrified vehicle 10 for VPP or V2H during the charging time.

The setting related to smart charging set by the mobile terminal 300 is transmitted to the server 400. The server 400 creates a charging and discharging plan using the information transmitted from electrified vehicle 10, the system managing server 100, and the residence 200 based on the input information regarding the smart charging setting from the mobile terminal 300.

The server 400 creates a charging and discharging plan so that the first request from the system managing server 100 can be achieved, for example, within a range in which the target SOC of the scheduled departure time of electrified vehicle 10 vehicles can be achieved when the user sets VPP use of electrified vehicle 10 during the charge period.

In addition, for example, when the user sets electrified vehicle 10 to be utilized in V2H during the charging period, the server 400 creates a charging and discharging plan such as supplying the electric power of the battery 11 to the electric power load facility 203 within a range in which the target SOC of the scheduled departure time of electrified vehicle 10 can be achieved by the information from the residence 200.

Note that the charging and discharging plan includes, for example, at least one of information indicating a charge start time, information indicating a charge end time, information indicating an electric power quantity of charge or discharge in respective time zones, and information indicating a target SOC at the end of charge. Then, the server 400 transmit the created charging and discharging plans to electrified vehicle 10.

### Configuring Electrified Vehicle

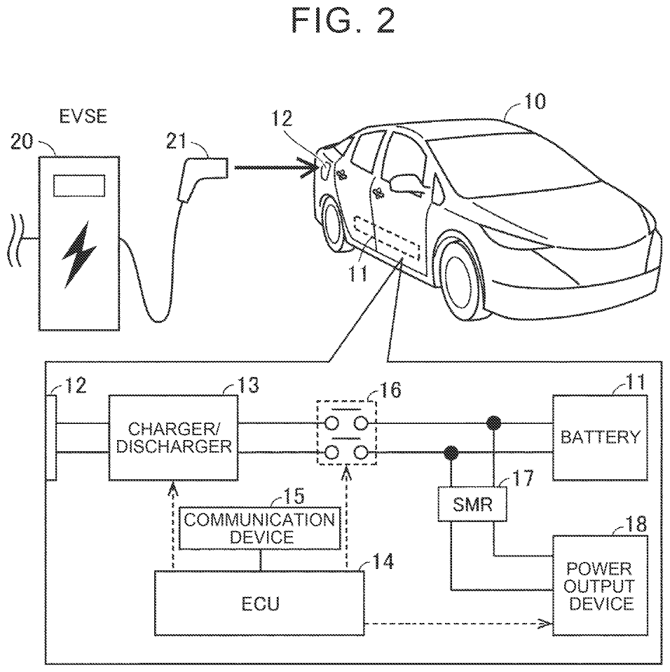

FIG. 2 is a diagram illustrating a configuration of an electrified vehicle 10 according to the present embodiment.

Electrified vehicle 10 includes a battery 11, a connector 12, a charger/discharger 13, an ECU (Electronic Control Unit) 14, a communication device 15, a charging relay 16, an SMR (System Main Relay) 17, and an electric power outputting device 18.

The battery 11 is provided in electrified vehicle 10 and can be charged using electric power supplied from EVSE 20. The battery 11 can also discharge the electric power of the battery 11 to EVSE 20.

Electrified vehicle 10 includes a plurality of sensors for detecting various physical quantities required for controlling electrified vehicle 10, such as a monitoring sensor for detecting a state (voltage, current, temperature, and the like) of the battery 11. The sensors are configured to transmit the detected data to ECU 14. The battery 11 is an example of a “secondary battery” of the present disclosure.

The connector 12 is formed to be electrically connectable to the electric power plug 21 of EVSE 20. A lid is provided on the outer surface of electrified vehicle 10, and the connector 12 is exposed to the outside by opening the lid.

The charger/discharger 13 and the charging relay 16 are provided between the connector 12 and the battery 11. The charger/discharger 13 is provided between the charging relay 16 and the connector 12.

The charger/discharger 13 is a device controlled by a control signal from ECU 14. The charger/discharger 13 converts the electric power discharged from the battery 11 into electric power that can be received by EVSE 20, and transmits the electric power to EVSE 20. The charger/discharger 13 includes, for example, bi-directional AC/DC converters.

SMR 17 is provided between the electric power outputting device 18 and a wire connecting the charging relay 16 and the battery 11. An ECU 14 and communication device 15 are also provided in electrified vehicle 10.

ECU 14 includes a processor (not shown) and memories. The processor controls the respective devices of electrified vehicle 10 based on information recorded in the memories and information acquired through the communication device 15 or the like. ECU 14 wirelessly or wirelessly communicates with EVSE 20 and the server 400 using the communication device 15. Note that ECU 14 is an exemplary “control device” of the present disclosure.

The communication device 15 is an interface for communicating with an external device (the system managing server 100, HEMS controller 204, the mobile terminal 300, the server 400, and the like) via a network. The communication device 15 transmits the information transmitted from ECU 14 to the device outside the vehicle, and transmits the information received from the device outside the vehicle to ECU 14.

EVSE 20 includes an electric power plug 21. the electric power plug 21 is formed to be connectable to the connector 12.

In electrified vehicle 10 configured as described above, for example, when the battery 11 is charged, the driving of the electric power outputting device 18 is stopped and SMR 17 is off.

the electric power plug 21 is connected to the connector 12. When ECU 14 detects that the electric power plug 21 is connected to the connector 12, it drives the charger/discharger 13 using the charging relay 16 as an on. Thus, the electric power from the electric power plug 21 is converted by the charger/discharger 13 and supplied to the battery 11. When the charging is completed, ECU 14 stops driving the charger/discharger 13 and turns off the charging relay 16.

When the electric power of the battery 11 is supplied to EVSE 20, the driving of the electric power outputting device 18 is stopped, and when SMR 17 is off, ECU 14 turns on the charging relay 16. ECU 14 drives the charger/discharger 13 and supplies electric power from the battery 11 to EVSE 20 through the connector 12.

### Electrified Vehicle 10 Charge Control Flow

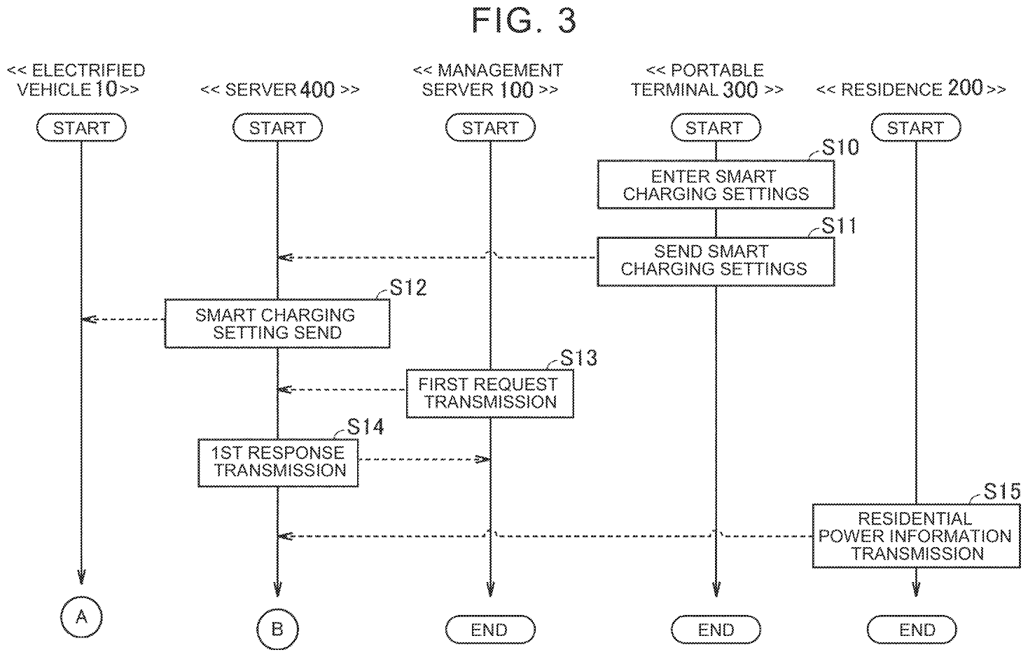

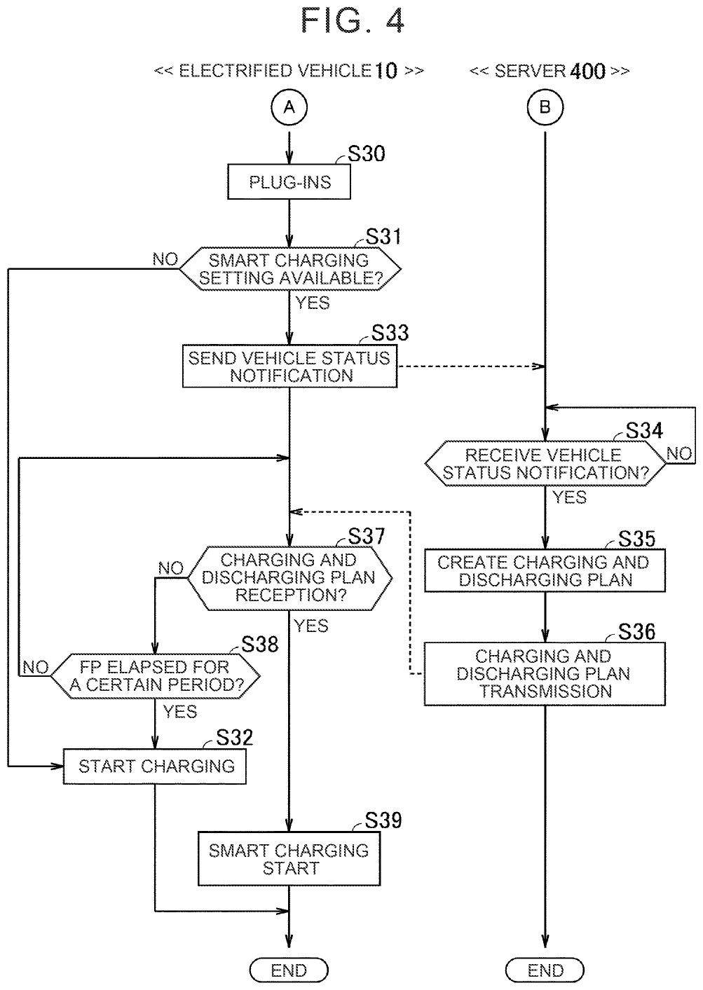

Next, referring to FIGS. 3 and 4, a control flow executed by electrified vehicle 10, the system managing server 100, the residence 200, the mobile terminal 300, and the server 400 will be described.

In S10 illustrated in FIG. 3, the user inputs the smart charging setting using the mobile terminal 300. In S11, the mobile terminal 300 transmits the smart charging settings inputted in S10 to the server 400.

In S12, the server 400 transmit information indicating that the smart charging setting has been made to electrified vehicle 10. Electrified vehicle 10 stores the smart charging settings in ECU 14's memories.

In S13, the system managing server 100 transmits a first request to the server 400. In S14, when the aggregator managing the server 400 determines to respond to the first request transmitted from the system managing server 100, the server 400 transmits the first response to the system managing server 100. The first response is a signal corresponding to the first request.

In S15, residence 200 transmits residential power info. The residential power information includes information on the respective devices connected to HEMS compatible distribution board 202 (the amount of power consumed by the electric power load facility 203 and the amount of power generated by the photovoltaic power generation facility 206) and the electricity rate of the electric power supplied from the electric power system PG. The residential power data is periodically transmitted until a S35 described later.

In S30 shown in FIG. 4, EVSE 20 electric power plugs 21 are connected to electrified vehicle 10 connectors 12.

In S31, electrified vehicle 10 checks whether it has received a message from the server 400 indicating that there is a smart charging setting. If ECU 14 determines that the smart charging setting has not been made, S31 is No, and S32 proceeds to ECU 14 process. In S32, ECU 14 switches the charging relay 16 from off to on and drives the charger/discharger 13 to charge the battery 11 with electric power supplied from EVSE 20. For example, when the battery 11 is fully charged, the flow ends. On the other hand, when ECU 14 determines that the smart charging has been set (Yes in S31), ECU 14 process proceeds to S33.

In S33, electrified vehicle 10 sends a vehicle-status notification to the server 400. The notification includes at least one of information indicating that the electric power plug 21 is connected to the connector 12, information indicating SOC of the battery 11, and information related to EVSE 20 to which electrified vehicle 10 is connected. Note that the information on EVSE 20 includes information indicating the charge upper limit power corresponding to EVSE 20, information on the residence 200 to which EVSE 20 is connected, and the like. Electrified vehicle 10 may acquire EVSE 20 information through a communication line provided in the charge cable.

In S34, the server 400 confirm whether a vehicle-status notification has been received from electrified vehicle 10. If the server 400 determines that the vehicle-status notification has not been received (No in S34), the server 400 processes S34 again. When the server 400 determines that the vehicle-state notification has been received (Yes in S34), the process of the server 400 proceeds to S35.

In S35, the server 400 creates a charging and discharging plan based on information acquired from the system managing server 100, the residence 200, the mobile terminal 300, and electrified vehicle 10. Specifically, the acquired information includes at least one of the setting related to the smart charging input by the user to the mobile terminal 300, the information of the second request, and the residential power information of the residence 200 to which EVSE 20 belongs.

In S36, the server 400 send charging and discharging plans to electrified vehicle 10. In S37, ECU 14 checks whether a charging and discharging plan has been received. When ECU 14 determines that the charging and discharging planning has been received (Yes in S37), ECU 14 proceeds to S39. If ECU 14 determines that the charging and discharging plan has not been received (No in S37), ECU 14 process proceeds to S38.

In S38, ECU 14 checks whether a fixed period of time FP has elapsed since S30 plug-in. ECU 14 determines that a fixed period of time FP has elapsed (Yes in S38), and the process of the ECU 14 proceeds to S32. In S32, ECU 14 drives the charger/discharger 13 to charge the battery 11 with electric power supplied from EVSE 20.

If ECU 14 determines that the fixed period of time FP has not elapsed (No in S10), the ECU 14 performs S37 again.

Here, the fixed period of time FP is, for example, about two seconds to 15 minutes, and is a period calculated after the electric power plug 21 is connected to the connector 12. Providing a limit in a period from when the electric power plug 21 is connected to the connector 12 to when the charging and discharging plan is received from the server 400 is significant in that the number of times of operation of the charging relay 16 is suppressed and that SOC of electrified vehicle 10 is secured.

Note that the creation time of the charging and discharging plan required by the server 400 is two seconds or more when the charging and discharging plan is created based only on the timer charging function. When the charging and discharging plan is created based on the eco-charging setting, the residential power information, and the second request, the creation time of the charging and discharging plan required by the server 400 is 15 minutes or less.

In S39, electrified vehicle 10 initiates a smart charging based on a charging and discharging plan. Specifically, ECU 14 that has received the charging and discharging plan from the server 400 by the communication device 15 transmits a control command for turning on/off the charging relay 16 in accordance with the charging and discharging plan. The charging relay 16, which has received the control command from ECU 14, operates on/off based on the control signal. After the smart charging is completed, electrified vehicle 10 turns off the charging relay 16, and the process ends.

### One Example of Charging and Discharging Plan

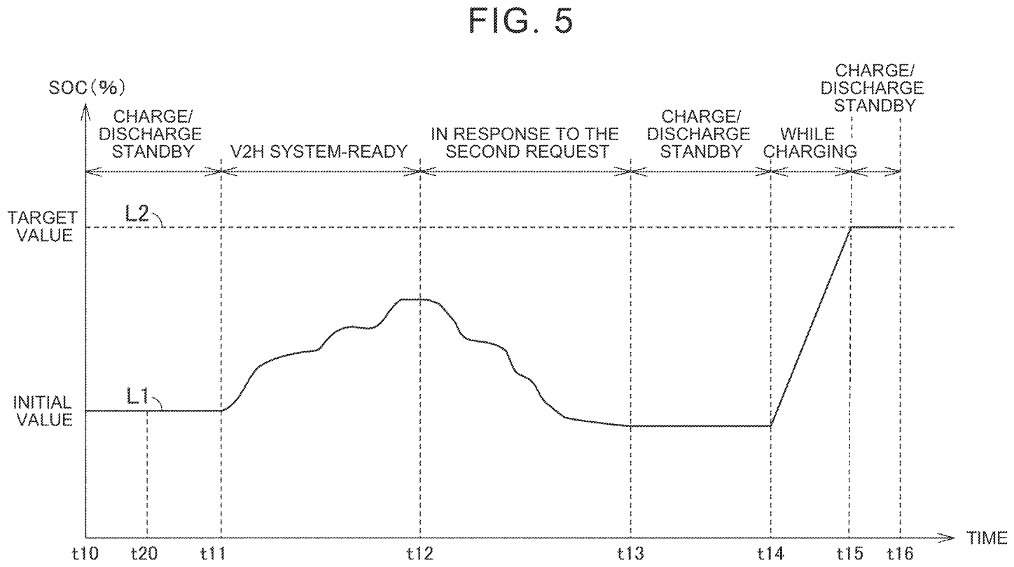

FIG. 5 is a diagram illustrating an example of a charging and discharging plan created by the server 400 in accordance with a setting input by the user in advance. In the charging and discharging plan shown in FIG. 5, information set by various users is also taken into consideration and formulated.

In the charging and discharging plan illustrated in FIG. 5, the information set by the user includes a scheduled vehicle departure time and a target SOC at the scheduled vehicle departure time. Further, in the embodiment illustrated in FIG. 5, the information set by the user includes a setting that electrified vehicle 10 battery 11 is used for VPP or V2H during the charge period, and a setting related to the electricity rate. The setting regarding the electric charge is, for example, a setting in which the electric charge is equal to or less than a predetermined charge between the time when the electric power plug 21 is connected to the connector 12 and the scheduled vehicle departure time.

In the embodiment illustrated in FIG. 5, the scheduled departure time is the time t16, and the target SOC is indicated by a broken line L2. Then, charging and discharging are planned such that SOC reaches the target SOC at the time t16 of the battery 11.

A charging and discharging plan created by the server 400 based on the smart charging setting will be described with reference to FIG. 5.

The line L1 indicates SOC of the battery 11 from the time when the electric power plug 21 is connected to the connector 12 to the time t16. The time t10 indicates the time when the electric power plug 21 is connected to the connector 12. In the time t10, the charging relay 16 are in off.

In the time t11 from the time t10, the battery 11 is not charged or discharged. That is, the charging relay 16 is maintained in off. Specifically, electrified vehicle 10 receives a charging and discharging plan from the server 400 after electrified vehicle 10 is connected to EVSE 20.

In the embodiment illustrated in FIG. 5, the charging and discharging plan is received at the time t20. Thereafter, electrified vehicle 10 waits based on the received charging and discharging plan.

In the time t12 from the time t11, electrified vehicle 10 makes V2H use of electrified vehicle 10 battery 11 based on the charging and discharging plan. That is, ECU 14 switches the charging relay 16 to on at the time t11. Then, ECU 14 drives the charger/discharger 13 to charge the battery 11 with the surplus power of the photovoltaic power generation facility 206.

In the time t13 from the time t12, electrified vehicle 10 corresponds to the electric power supply and demand adjustment request based on the charging and discharging plan. Specifically, during a period from the time t11 to the time t12, the electric power stored in the battery 11 is discharged to the electric power system PG.

In the time t14 from the time t13, the battery 11 is not charged or discharged. It should be noted that the charging relay 16 remains in an on state during the time period from the time t13 to the time t14.

From the time t14 to the time t15, the battery 11 is charged to the target SOC. When the charging is completed at the time t15, the charging relay 16 are turned off. From the time t15, electrified vehicle 10 waits for the departure, and at the time t16, the charging and discharging planning ends.

In the charging and discharging planning illustrated in FIG. 5, the electricity rate from the time t14 to the time t15 is lower than the electricity rate from the time t13 to the time t14. Further, in the setting of the user, the electricity rate is set to be the lowest in the period up to the scheduled vehicle departure time. Therefore, in the charging and discharging plan, charge is planned from the time t14 to the time t15.

### Functions of Charge/Discharge Control System 1

The function of the charge/discharge control system 1 formed as described above will be described.

In a conventional electrified vehicle, when electrified vehicle is connected to EVSE, regardless of whether the electrified vehicle has a smart charging setting, the charging relays are switched on. Thereafter, electrified vehicle that has acquired the discharge plan determines that the current electrified vehicle does not need to be charged and discharged based on the plan, and switches the charging relays to off.

As described above, in the conventional electrified vehicle, there is a problem that the number of times of on/off of the charging relay may increase due to the driving of the charging relay when the vehicle is connected with the smart charging.

According to an electrified vehicle 10 of an embodiment of the present disclosure, when smart charging is set in electrified vehicle 10, off of the charging relay 16 is maintained the fixed period of time FP even after the electric power plug 21 is connected to the connector 12. Therefore, when the charging and discharging plan is received during the fixed period of time FP, the charging relay 16 maintains off until the charge starting time in the charging and discharging plan is reached. Therefore, according to electrified vehicle 10 of the present disclosure, the number of times of on/off of the charging relay 16 can be suppressed as compared with the conventional electrified vehicle.

Further, electrified vehicle 10 performs charging and discharging in accordance with a charging and discharging plan created based on the target SOC of the vehicle departure scheduled time and the vehicle departure scheduled time of electrified vehicle 10 set by the user. Note that the user can appropriately change the charging and discharging plan according to his/her own convenience by changing the setting to be input to the mobile terminal 300.

Electrified vehicle 10 according to the present disclosure sets a charging and discharging plan according to a first request (electric power supply and demand adjustment request), and the user can use VPP, and the user can obtain a reward from the server 400.

In electrified vehicle 10 according to the present disclosure, the fixed period of time FP is two seconds to 15 minutes. Providing a fixed period of time is significant in that the number of times of on/off of the charging relay 16 is suppressed and that SOC at the time of starting electrified vehicle 10 is secured.

For example, if the lower limit is not provided a fixed period of time FP, when the electric power plug 21 is connected to the connector 12, electrified vehicle 10 turns on the charging relay 16 and starts charging prior to the server 400 completing the creation of the charging and discharging plan. After that, when electrified vehicle 10 receives the charging and discharging plan, electrified vehicle 10 needs to drive the charging relay 16 to off according to the charging and discharging plan until the charge is started. Consequently, the number of times of on/off of the charging relay 16 may increase.

In addition, if the upper limit is not provided the fixed period of time FP, if there is a server down of the server 400 or a communication failure between the communication device 15 and the server 400, electrified vehicle 10 continues to wait for reception of the charging and discharging plan, and there is a possibility that electrified vehicle 10 is not charged at the time of departure.

In the above embodiment, an example in which the smart charging setting is performed by an input to the mobile terminal 300 has been described, but the present disclosure is not limited thereto. For example, an electrified vehicle 10 may have an HMI device and a user of electrified vehicle 10 may enter a smart charging setting into HMI device. The information inputted to HMI device is transmitted to the server 400 by the communication device 15.

The embodiments disclosed herein should be understood as exemplary in all respects and not limiting. The scope of the present disclosure is defined by the terms of the claims, and is intended to include any modifications within the scope and meaning equivalent to the terms of the claims.

What is claimed is:

1. An electrified vehicle comprising:
a connector to which an electric power plug provided externally is connected;
a secondary battery;
a charging relay provided between the connector and the secondary battery; and
a control device that controls at least one of charging and discharging of the secondary battery, wherein when smart charging of the electrified vehicle is set, the charging relay remains off for a fixed period of time after the electric power plug is connected to the connector.

2. The electrified vehicle according to claim 1, wherein:
the control device is configured to be able to communicate with a server;
the server is able to communicate with a user terminal used by a user of the electrified vehicle;
a setting of the smart charging is set based on input information from the user terminal; and
the control device receives a charging and discharging plan set by the server based on the input information.

3. The electrified vehicle according to claim 1, wherein:
the control device is configured to be able to communicate with a server;
the server sets a charging and discharging plan of the electrified vehicle according to an electric power supply and demand adjustment request for adjusting power supply and demand in an electric power system; and
the control device receives the charging and discharging plan from the server.

4. The electrified vehicle according to claim 2, wherein when the charging and discharging plan is not received after a lapse of the fixed period of time, the charging relay is turned on.

5. The electrified vehicle according to claim 1, wherein the fixed period of time is two seconds or more and 15 minutes or less.
